(19) United States
(12) Patent Application Publication
(10) Pub. No.: US 2003/0056656 A1
(43) Pub. Date: Mar. 27, 2003

(54) Device for basting chicken

(76) Inventor: Nicholas F. Marco JR., Joliet, IL (US)

Correspondence Address: DONALD G. FLAYNIK, JR., CHERSKOV and FLAYNIK, Suite 1447, 20 NORTH WACKER DR., CHICAGO, IL, 60606, US

(21) Appl. No.: 09/963,955

(22) Filed: Sep. 26, 2001

(51) Int. Cl. A47J 37/10; A47J 43/18

(52) U.S. Cl. 99/345; 426/523; 99/426

(57) ABSTRACT

A device 10 for basting a chicken on a barbeque grill or in an oven includes a base plate 16 and a plurality of rods 20 perpendicularly joined to a top wall 36 of the base plate 16 such that a full beer can 22 may be snugly inserted between the rods 20 until the bottom of the beer can engages the top wall 36 of the baseplate 16 thereby maintain the beer can 22 in a substantially vertical position when opened and inserted with the rods 20 into the posterior end 24 of a chicken 18. The device maintains the beer can 22 and chicken 18 substantially vertical throughout the cooking process to promote the evaporation of the beer from the can 22 into an internal cavity of the chicken 18, thus basting the chicken 18 from the inside to the outside, resulting in a more uniformly basted and cooked chicken 18.

### BACKGROUND OF THE INVENTION

1. Field of the Invention

The present invention relates to basting foods and more particularly, to a device that provides for basting chicken on a barbeque grill or in an oven.

2. Background of the Prior Art

Barbequing chicken on the back yard barbeque is a common occurrence during the summer months. A favored method of barbequing the chicken is to baste the chicken with beer during the cooking process. A common technique used to administer the beer to the chicken is to pour the beer from an open beer can upon the chicken which is setting upon a heated grill. Some of the beer will evaporate upon engaging the heated chicken thereby adding flavor to the chicken as it continues to cook. However, most of the beer will fall upon the heated grill and the hot coals or stones or similar heating members underneath the grill resulting in hot vapor rising up to ultimately engage the cooks hands and face causing injury or discomfort as a minimum. Further, the beer contacting the heating members may extinguish the flames emanating therefrom resulting with the rekindling of the respective heating members and the non-uniform cooking and basting of the chicken.

Alternatively, baking a chicken in an oven is a common technique for cooking chicken. Beer basting an oven cooked chicken, requires an individual to remove the chicken from the oven and pour beer over the hot chicken resulting in the beer quickly evaporating and little if any flavor being added to the chicken.

Therefore, a device is required that allows a cook to safely add a basting material or liquid (beer) to a barbequing chicken or other food items being cooked. The device must be capable of maintaining the horizontal and vertical position of an open container (beer can). Further, the device must be capable of maintaining a chicken in a stable, substantially vertical position after the open beer can has been inserted into an internal cavity via an aperture in the posterior end of the chicken. The device must also promote the uniform cooking and basting of the chicken in a closed oven, or when placed on a barbeque grill with a cover disposed thereupon.

### SUMMARY OF THE INVENTION

It is an object of the present invention to overcome many of the disadvantages associated with basting barbeque or oven baked chicken.

A principle object of the present invention is to provide a device for basting chicken on a barbeque grill or in a pan. A feature of the device is a relatively “heavy” baseplate. An advantage of the device is that the baseplate can maintain a preselected position for the chicken.

Another object of the present invention is to baste the chicken quickly. A feature of the device is a cross configured base plate having opposing longitudinal members substantially longer than adjacent lateral members. An advantage of the device is that heat rising adjacent to the lateral members engages front and back portions of the chicken thereby cooking larger surface areas of the chicken more quickly.

Yet another object of the present invention is to maintain the vertical and horizontal positions of a container for the basting fluid. A feature of the device is four rods perpendicularly joined to a top wall of the baseplate such that the rods that are configured to form a square that snugly receive the container therebetween. An advantage of the device is that the top of the container can be opened without spilling the contents therein.

Still another object of the present invention is to maintain the vertical and horizontal positions of a chicken while basting same. A feature of the device is longitudinally dimensioning the four rods detailed above to extend into and through an inner cavity of the chicken via an aperture in the posterior end. An advantage of the device is that the edible portions of the chicken are uniformly cooked. Another advantage of the device is that the basting fluid in the container is quickly evaporated to more quickly and uniformly baste the chicken as it cooks.

Another object of the present invention is to promote the unobstructed insertion of the rods into the chicken. A feature of the device is the rounding of the top ends of the rods. An advantage of the device is that the chicken is easily positioned upon the rods before cooking and easily removed from the rods after cooking.

Another object of the present invention is to utilize a beer can as the basting container and the beer therein as the basting fluid. A feature of the device is the dimensioning and configuration of the baseplate and rods to snugly a beer can to maintain the horizontal and vertical orientation of the beer can. An advantage of the device is that beer may be the basting fluid. Another advantage of the device is that the beer can, with its configuration and dimensions, cooperates with the rods to stabilize the chicken when inserted into the chicken to orientate the chicken in a substantially vertical position.

Briefly, the invention provides a device for basting a chicken comprising a container having a basting fluid therein, said container being configured to removably insert into a cavity in the chicken; means for maintaining the horizontal and vertical positions of said container with the chicken disposed thereupon; and means for transferring heat from the cooking means to said container.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a perspective view of a device for basting a chicken in accordance with present invention.

FIG. 2 is a top elevation view of the device of FIG. 1.

FIG. 3 is a front elevation view of the device of FIG. 1.

FIG. 4 is a side elevation view of the device of FIG. 1.

FIG. 5 is a perspective view of the device with a beer can disposed above, the beer can ultimately being snugly inserted between four vertical rods.

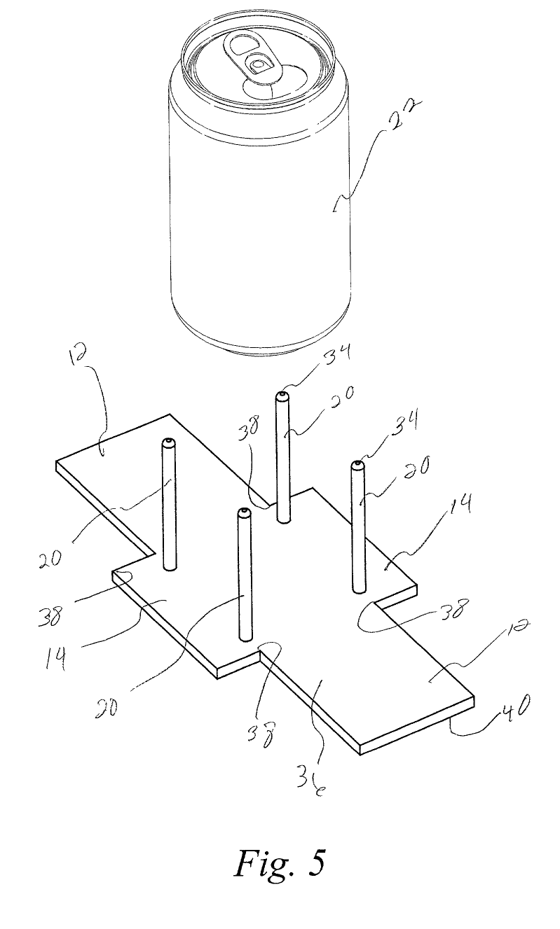

FIG. 6 is a perspective view of the device of FIG. 5 with the beer can inserted between the four rods.

FIG. 7 is a perspective view of the device with a beer can disposed above the device for insertion between four rods, and with a chicken disposed above the beer can to receive the beer can and rods via a posterior aperture.

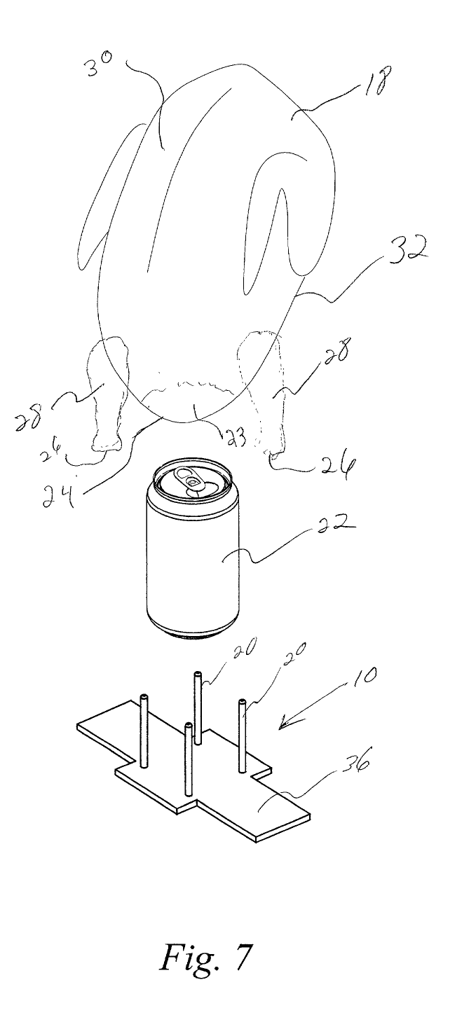

FIG. 8 is a perspective view of the device of FIG. 7 with the beer can and four rods inserted inside the chicken via the posterior end.

### DETAILED DESCRIPTION OF THE PREFERRED EMBODIMENT

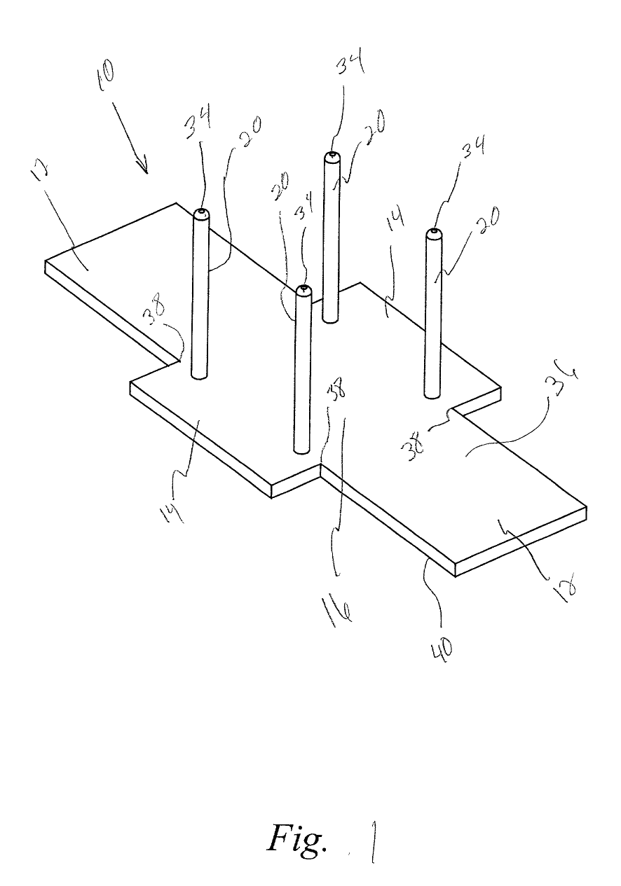

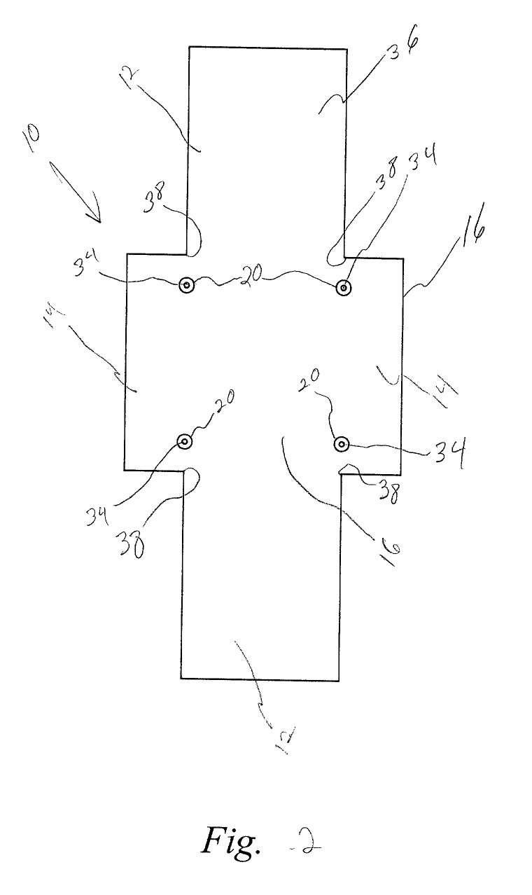

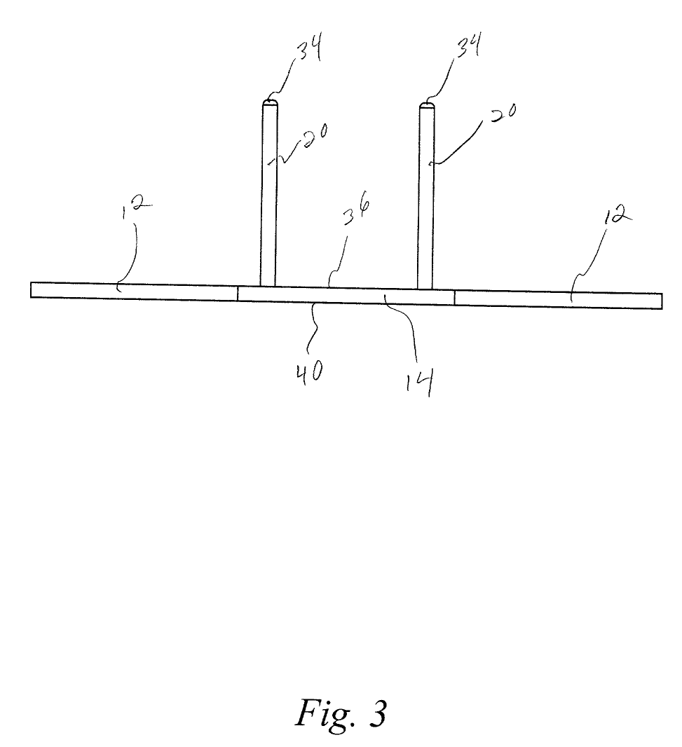

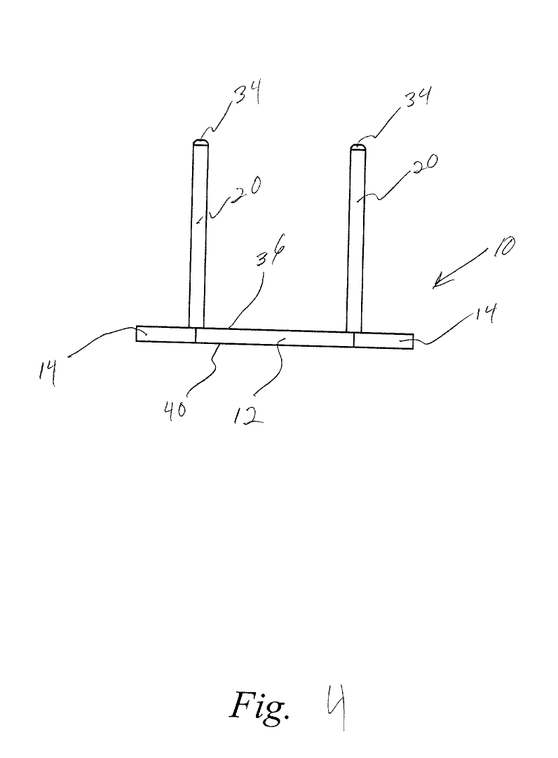

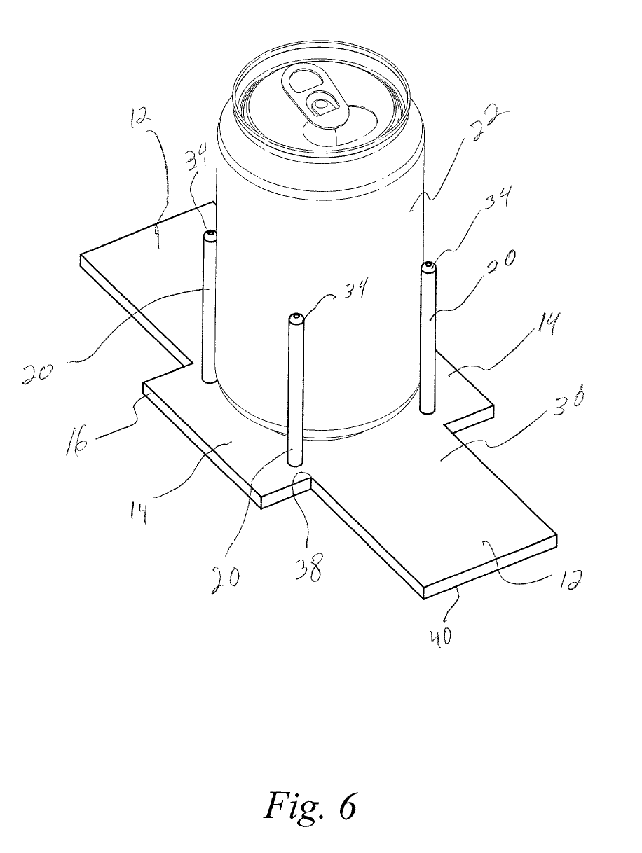

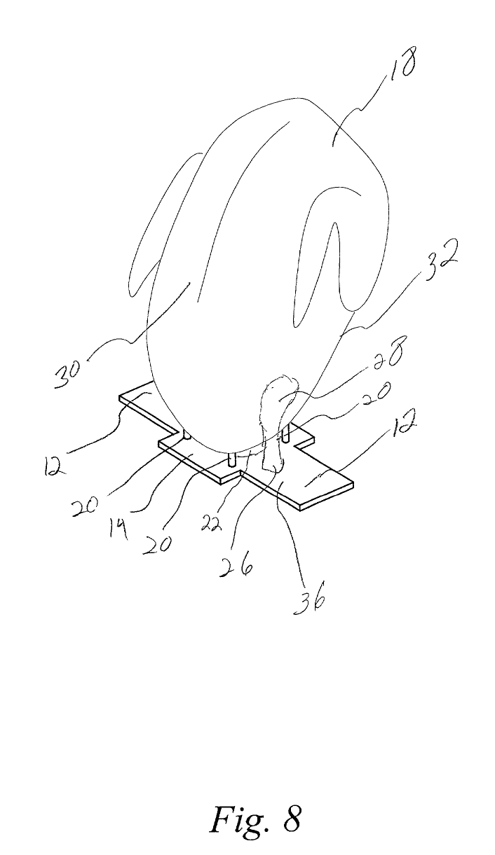

Referring now to the figures and in particular to FIGS. 1-4, a device for basting a chicken is denoted by numeral 10. The device 10 is fabricated from a relatively “heavy” metal with stainless steel being the material of choice. The device 10 includes longitudinal 12 and lateral 14 crossing members dimensioned to form a baseplate 16 having sufficient weight and planar surface area to maintain a chicken 18 (see FIG. 8) in a substantially vertical position. The device 10 may be punched from a single piece of metal or be assembled by welding together a plurality of metal plates. The device 10 includes a plurality (typically four) of substantially vertical rods 20 disposed to snugly engage the periphery of a cylindrical, vertical container 22 (see FIG. 6) having a basting fluid therein.

Generally, the device 10 is configured to facilitate the vertical positioning of a chicken 18 upon a grill (not depicted) with a cover or in an oven (not depicted) to optimize heat transfer to the chicken 18 to quickly evaporate a basting fluid in the container 22. The container 22 is typically an open, full can of beer snugly placed between the four vertical rods 20. The chicken 18 receives the open beer can 22 and four rods 20 via an aperture 23 in the posterior end 24. The longitudinal members 12 of the device are dimensioned to stabilize the vertical chicken 18 and to engage end portions 26 of the legs 28 of the chicken 18. The lateral members 14 are substantially shorter than the longitudinal members 12 and are dimensioned to help stabilize the vertical chicken 18, but more importantly, to allow rising heat from the barbeque grill to engage front and back portions 30 and 32 of the chicken 18 thereby increasing heat transfer to the beer can 22 inside the chicken 18 and increasing the rate of evaporation of the beer to more quickly baste the chicken. The dimensioning of the longitudinal and lateral members 12 and 14, as well as the “thickness” of the base plate, must be sufficient to maintain the vertical position of the chicken 18 not only with a fill beer can 22 therein, but also as the beer evaporates which causes the center of gravity of the chicken 18-beer can 22 combination to vary with the level of beer in the can 22.

Besides being used to baste chickens 18, the device 10 may be used to baste turkey, ham, zucchini and other large foods so long as an exterior aperture and cavity within are provided. Also, the container size may vary to provide more basting material which may include liquids other than beer. The dimensions of the longitudinal and lateral members 12 and 14, and the thickness of the baseplate 16 must be correspondingly increased to maintain the larger food item in a substantially vertical position. Although the device 10 could be utilized to position a food item in a horizontal orientation, the basting process would take longer and would not baste the food item uniformly from inside to out compared to the basting of the food item when disposed vertically.

The vertical rods 20 are cylindrically configured with “rounded” ends 34 to facilitate the insertion of the rod 20 into the posterior end 24 of the chicken 18. The rods 20 have relatively small diameters but include longitudinal dimensions that cause the rods to extend parallel to the axis of the beer can 22 and into the chicken 18 a distance that maintains the vertical position of the chicken 18 and the beer can 22 inserted therein irrespective of the changing form of the chicken 18 as the barbeque grill or similar heating means cooks the chicken 18. The rods 20 are disposed to form a relatively square configuration, when taking a top elevation view of the device 10, that causes the rods 20 to snugly engage the periphery of the beer can 22 to prevent horizontal movement of the beer can 22 relative to the base plate 16 of the device 10 thereby further stabilizing the beer can 22 and chicken 18 when disposed upon device 10.

In operation, a device 10 for basting a chicken 18 on a barbeque grill is assembled from a plurality of metal plates or “punched” from single plate to form a baseplate 16 having opposing longitudinal and lateral members 12 and 14 that form a relatively “crossed” configuration. Four equally spaced and vertically positioned rods 20 are integrally joined to a substantially planar top wall 36 of the base plate 16 such that the rods are disposed adjacent to four corresponding corners 38 formed by the longitudinal and lateral members 12 and 14. The base plate 16 includes a bottom planar wall 40 that stabilizes the baseplate 16 when the device 10 is disposed upon a barbeque grill or other relatively planar surface. An open, full beer can 22 or similar container having an evaporable basting material therein is snugly inserted within the rods 20 such that a cylindrical outer wall of the beer can 22 engages all the rods 20. The beer can 22 and rods 20 are inserted into a chicken 18 via an aperture 23 in the posterior end 24 such that end portions 26 of the legs 28 and the posterior end 24 of the chicken 18 engage the upper wall 36 of the longitudinal members 12. When inserting the device 10 and open beer can 22 into the chicken 18, care must be taken to insure that the contents of the beer can 22 are not spilled. Upon completing the insertion process, the device 10 with the beer can 22 and chicken 18 positioned thereon, is placed upon the grill of a heated barbeque or similar cooking apparatus. To facilitate faster evaporation of the basting fluid and a more uniformly cooked chicken, a cover is placed over the grill and chicken.

The foregoing description is for purposes of illustration only and is not intended to limit the scope of protection accorded this invention. The scope of protection is to be measured by the following claims, which should be interpreted as broadly as the inventive contribution permits.

1. A device for basting a chicken comprising:
a container having an opening and a basting fluid therein, said container being configured to removably insert into a cavity in the chicken;
means for maintaining the horizontal and vertical positions of said container with the chicken disposed thereupon; and
means for transferring heat from the cooking means to said container.

2. The device of claim 1 wherein said container includes a beer can.

3. The device of claim 1 wherein said container inserts into the chicken via the posterior end.

4. The device of claim 1 wherein said maintaining means includes means for positioning the chicken substantially vertical.

5. The device of claim 1 wherein said maintaining means includes a relatively heavy base plate.

6. The device of claim 1 wherein said maintaining means includes a planar base plate having a relatively large surface area for engagement with a barbeque grill.

7. The device of claim 1 wherein said maintaining means includes a container positioning member.

8. The device of claim 7 wherein said container positioning member includes a plurality of substantially vertical rods disposed to engage the periphery of said substantially vertical container.

9. The device of claim 1 wherein said heat transferring means includes fabricating said base plate and said container positioning member from metal.

10. The device of claim 1 wherein said heat transferring means includes a cover disposed upon the barbeque grill.

11. A chicken basting device comprising:
means for positioning a chicken upon a cooking means;
means for containing a basting fluid; and
means for disposing said containing means inside said positioned chicken.

12. A method of basting food, said method comprising the steps of:
positioning the food in a cooking means; and
disposing a basting fluid inside the food, said basting fluid to be evaporated by heat from the cooking means whereby the food is basted.

13. The method of claim 12 wherein the step of positioning the food in a cooking means includes the step of providing a relatively heavy base plate.

14. The method of claim 12 wherein the step of positioning the food in a cooking means includes the step of orientating the food substantially vertical.

15. The method of claim 12 wherein the step of positioning the food in a cooking means includes the step of providing a planar base plate having a relatively large surface area for engaging a supporting surface of the cooking means.

16. The method of claim 12 wherein the step of disposing a basting fluid includes the step of providing an open container to be inserted inside the food.

17. The method of claim 16 wherein the step of providing a container includes the step of providing an open beer can.

18. The method of claim 17 wherein the step of providing a beer can includes the step of inserting said beer can into the food via the posterior end.

19. The method of claim 12 wherein the step of positioning the food in a cooking means includes the step of orientating the food and an open container therein substantially vertical.

20. The method of claim 12 wherein the step of disposing a basting fluid inside the food to baste the food via heat from the cooking means includes the step of covering the food when positioned upon a grill.
